(19) United States
(12) Patent Application Publication
(10) Pub. No.: US 2013/0255870 A1
(43) Pub. Date: Oct. 3, 2013

(54) COMBINED EDGE SEALING AND EDGE PROTECTION OF MULTI-LAYERED REFLECTORS

(71) Applicants: Brian Wares, Sacramento, CA (US); Amine Berrada Sounni, Berkeley, CA (US); Matthew Dawson, Menlo Park, CA (US)

(72) Inventors: Brian Wares, Sacramento, CA (US); Amine Berrada Sounni, Berkeley, CA (US); Matthew Dawson, Menlo Park, CA (US)

(73) Assignee: SUNPOWER CORPORATION, San Jose, CA (US)

(21) Appl. No.: 13/436,666

(22) Filed: Mar. 30, 2012

(51) Int. Cl. B32B 38/00; B32B 37/12

(52) U.S. Cl. 156/216; 156/305

(57) ABSTRACT

The area of Concentrating Solar Power (CSP) and Concentrating Photovoltaics (CPV) require reliable, robust and durable reflectors capable of withstanding different environments, weather and transportation conditions. It is therefore important to use a method for fabricating a reflector which seals a reflector edge against moisture, corrosion and contaminants and protects the edge from cracks and damage. Embodiments of this method include depositing a clear sealant over the reflector edges, extending a reflective film over the edges of the reflector then sealing from the back and laminating a flexible strip of a clear polymer such as PVB and EVA around the top edge, a bottom edge, and all side edges of the reflector. Another embodiment includes performing hemming process on a front assembly of the reflector over the edges of a back assembly forming a sacrificial layer at the back of the reflector to prevent delamination.

### TECHNICAL FIELD

Embodiments of the subject matter described herein relate generally to solar reflectors. More particularly, embodiments of the present subject matter relate to reflector components, reflective films, reflector edge protection and methods for assembly.

### BACKGROUND

Glass mirrors and film-based reflectors are used in the area of Concentrating Solar Power (CSP) and Concentrating Photovoltaic (CPV) systems. Film-based reflectors typically include a reflective film adhered to a glass substrate or other suitable substrate.

In some known arrangements, the edge of the reflective layer is exposed to the elements which risks damage that can destroy its reflective functionality. Moreover, when a reflective layer deteriorates due to exposure to air, moisture, or other damaging agents, the defect can propagate through the material and cause further damage inward from the edges. As a result, it can be advantageous to improve the sealing of reflective film edges in solar reflectors.

### BRIEF DESCRIPTION OF THE DRAWINGS

A more complete understanding of the subject matter can be derived by referring to the detailed description and claims when considered in conjunction with the following figures, wherein like reference numbers refer to similar elements throughout the figures.

FIG. 1 is a schematic perspective view of a solar reflector fabricated in accordance with an embodiment;

FIGS. 2-5 are schematic cross-sectional diagrams of a reflector in different states during fabrication, in accordance with an embodiment;

FIGS. 6-11 are schematic cross-sectional diagrams of a reflector in different states during fabrication in accordance with another embodiment;

FIGS. 12-15 are schematic cross-sectional diagrams of a reflector in different states during fabrication in accordance with yet another embodiment;

FIG. 16 is an enlarged and partial cross-section view of an embodiment of an edge sealant dispenser adjacent an edge of a solar reflector;

FIG. 17 is an enlarged and partial cross-sectional view of another embodiment of an edge sealant dispenser adjacent an edge of a solar reflector;

FIGS. 18-22 are schematic cross-sectional diagrams of a reflector in different states of fabrication in accordance with yet another embodiment;

FIGS. 23-25 are schematic cross-sectional diagrams of a reflector in different states of fabrication in accordance with still another embodiment; and

FIGS. 26-30 are flow charts representing optional methods for fabricating reflectors.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Methods for sealing and protecting the edges of devices, such as reflectors, are disclosed herein. The methods described herein can be performed to make a reflector which includes a rigid substrate having a front side configured to face the sun during normal operation and a back side opposite the front side. The reflector can have a top edge, a bottom edge and two opposite side edges. The method can comprise adhering a reflective film to at least the front side of the rigid substrate to form a reflective upper surface. Further, a sealant can be deposited in a first state around the top edge, the bottom edge, and the side edges of the reflector. The method can further comprise curing the sealant to a second state. The first state can be a flowable state, and the second state can be a solid state.

Another method for sealing and protecting the edge of a reflector can be performed to make a reflector which includes a rigid substrate having a front side configured to face the sun during normal operation and a back side opposite the front side. The reflector can have a top edge, a bottom edge and two opposite side edges. The method can comprise adhering a reflective film to at least the front side of the rigid substrate to form a reflective upper surface. A hollow mold can be coupled along the edges of the reflector, and the sealant can be dispensed into the mold along the edges of the reflector. Subsequent to dispensing the sealant into the mold, a curing step can be performed. Subsequent to the curing step, the mold can be removed from the edges of the reflector without removing the sealant to form a reflective upper surface.

Still another method for sealing and protecting the edge of a reflector can be used to make a reflector which includes a rigid substrate having a front side configured to face the sun during normal operation and a back side opposite the front side. The method can comprise adhering a reflective film to at least the front side of the rigid substrate, extending over a top, bottom and side edges of the rigid substrate to form a reflective upper surface. A sealant can be applied at the back side of the reflector along the bottom edge. A curing process can be performed along the back side and the edges to melt the sealant into position.

Yet another method for forming an assembled reflector can be used to make a reflector which includes a front assembly having a flange portion and a back assembly having an engagement flange. A reflective film can be adhered to at least the front assembly to form a reflective upper surface. The method can comprise coupling the front assembly to the back assembly, and securing the front assembly to the back assembly by folding the flange portion of the front assembly over and around edges of the back assembly to couple to the engagement flange.

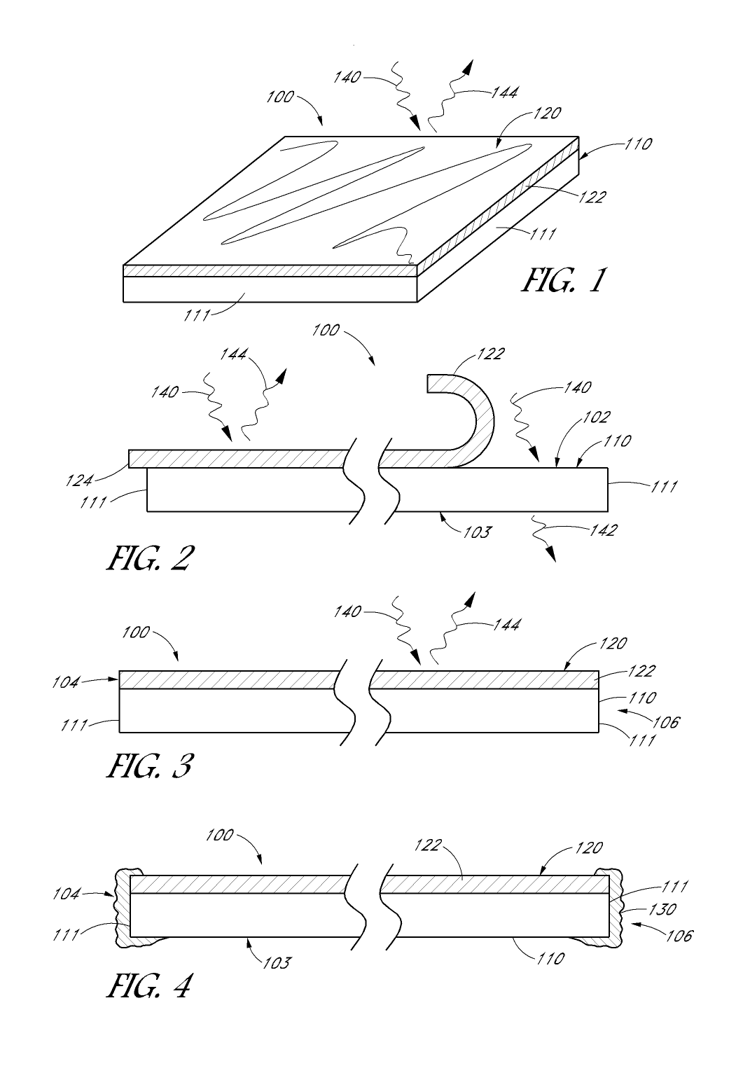

FIGS. 1-29 illustrate various embodiments for sealing and protecting the edges of a reflector. The various steps need not be performed in the order described below, and the disclosed methods can be incorporated into a more comprehensive procedure, process or fabrication technique having additional functionality not described in detail herein.

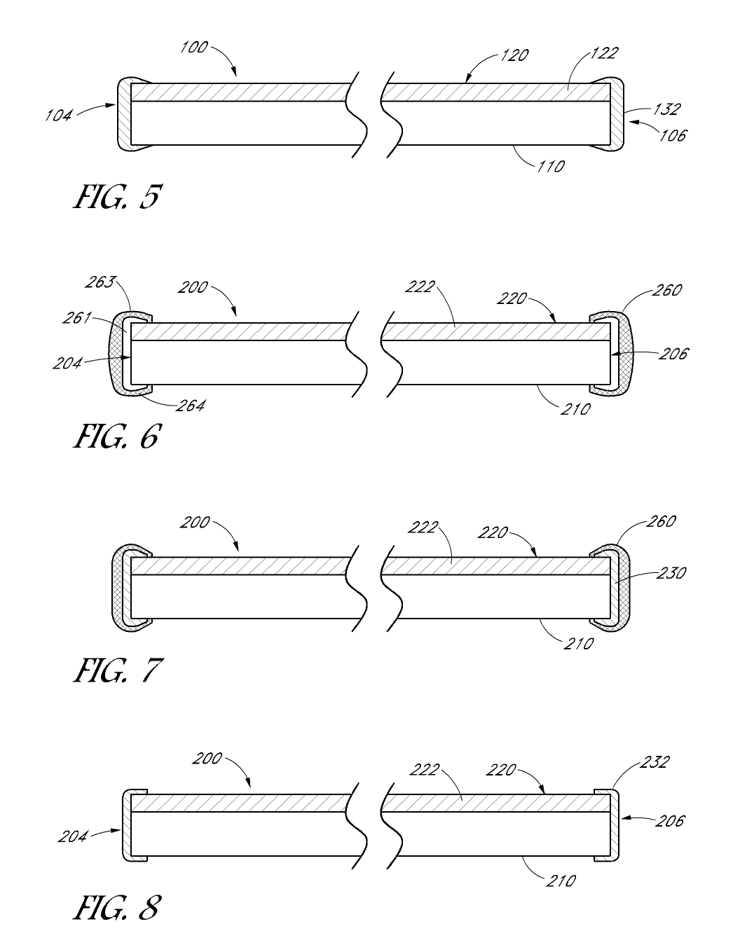

FIGS. 1-3 illustrate different states of fabrication of an embodiment of a method for fabricating a reflector 100 which includes a rigid substrate 110 and a reflective film layer 122 that defines a reflective upper surface 120 of the reflector 100. FIGS. 1 and 3 illustrate the reflector 100 in an assembled state.

The reflective film layer 122 can be mechanically coupled to the rigid substrate 110. In some embodiments, the rigid substrate 110 can be a glass substrate, however, in other embodiments, other suitable substrates can be used. For example, in some arrangements, a metal (e.g., sheet metal and other types of formed metal) can be used as the rigid substrate 110. In one embodiment, the rigid substrate 110 can be a plastic molded substrate. In another embodiment, the rigid substrate 110 can be a fiberglass substrate. In certain embodiments, the reflective film layer 122 can comprise an acrylic sublayer, silver sublayer and a copper sublayer. Moreover, the rigid substrate 110 can comprise, or can be mounted upon, a metal backing with ribs. In other embodiments, the rigid substrate 110 can comprise, or can be mounted upon, a front surface plate joined to a back surface plate that forms a composite backing structure.

The rigid substrate 110 can have a front side 102 configured to face the sun during normal operation and a back side 103 opposite the front side 102. The substrate 110 can also have lateral-facing side surfaces 111 extending along the top, bottom, and two opposite side edges of the substrate 110. As illustrated in FIG. 1, the reflective upper surface 120 of the reflector 100 reflects incident light 140 to form reflected light 144.

While the reflector 100 shown in FIGS. 1 and 3 is substantially planar, it should be appreciated that the reflector 100 can also be shaped three-dimensionally, for example, to form a concavity. In embodiments with a concave substrate 100, the reflective film 122 can be attached to the concave surface of the substrate 110 to form a parabolic mirror for use in a solar reflection and/or concentration apparatus. Other substrate shapes can also be used. Also, although only one reflector 100 is illustrated herein, the reflector 100 can be used as one in an array of multiple reflectors within a solar collection system.

As illustrated in FIGS. 1-3, the reflective film 122 can define the reflective upper surface 120 of the reflector 100. The reflective film 122 can be rolled and laminated onto the front side 102 of the rigid substrate 110, as shown in FIG. 2. In some embodiments, an adhesive material can be applied to the front side 102 of the rigid substrate 110 and/or the reflective film 122 in order to attach the reflective film 122 to the rigid substrate 110. Excess reflective film 124 can either be removed or rolled over and around to protect and seal the edges of the rigid substrate 110. The reflective film 122 can include a silver or aluminum film, although other reflective material combinations can also be used. In other embodiments, the reflective surface 120 can be formed on a glass substrate using a wet solution of silver and/or copper.

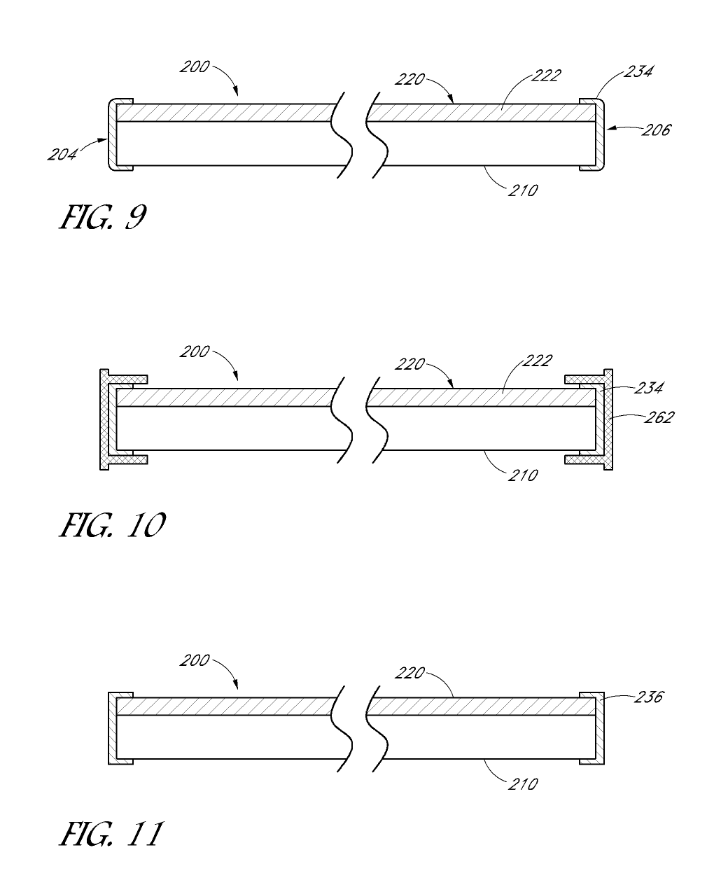

With reference to FIGS. 4-5, further embodiments for sealing and protecting the edges of a reflector 100 are disclosed. As illustrated in FIG. 4, a sealant in a first state 130 can be dispensed on a first edge 104 and a second edge 106 of the reflector 100 to cover the edges of both the reflective film 122 and the rigid substrate 110. Additionally, the rigid substrate 110 can comprise a sheet of glass. While FIGS. 4 and 5 illustrate applying sealant to only two edges 104, 106, it should be appreciated that the sealant can also be applied on the other two edges of the reflector 100.

Optionally, the sealant 130 can be applied in a manner so as to extend over the lateral-facing side surfaces 111 of the substrate 110. For example, the sealant 130 can be applied such that the sealant 130 extends in a substantially continuously along the periphery of the film and laterally-facing side surfaces 111 of the top, bottom, and two opposite side edges of the substrate 110. As used herein, “substantially continuously” can be considered to include gaps along the path of the sealant wherein the cumulative size of the all of the gaps total no more than about 5% of the length of the periphery of the substrate 110. In some embodiments, the sealant 130 can extend continuously along the periphery of the reflector 100 without any gaps.

The deposited sealant in a first state 130 can have a thickness of less than about 5 mm as measured from the laterally-facing side surfaces 111 of the rigid substrate 110 to along the two edges 104, 106, of the reflector 100. The sealant can also be applied on the other two edges of the reflector 100.

Further, in some embodiments, the sealant 130 can be applied so as to extend from the film 122, downwardly onto the substrate 110, over the laterally-facing side surfaces 111 of the substrate and onto the back side 103 of the substrate 110. Additionally, similarly to that described above, the sealant 130 can extend substantially continuously along the periphery of film 122 and the back side 103, or continuously without gaps.

In some arrangements, it can be advantageous to employ an optically transparent sealant. As illustrated, a portion of the sealant can be applied to the reflective surface 120 of the reflector 100. If a non-transparent sealant is used, then the sealant can block part of the reflecting surface of the reflector 100, thereby decreasing the power efficiency of the system. In some embodiments, a sealant with a refractive index of about 1.5 can be used. In addition, the sealant can be selected such that it transmits at least about 50% of incident light to the underlying reflective surface 120 (e.g., for a spectral window for light transmission of at least about 50%). One suitable transparent sealant is silicone. Another suitable sealant is ethylene-vinyl acetate (EVA), however, other transparent sealants may be suitable if they sufficiently seal the edges of the solar reflector 100. In the first state 130, the sealant can be flowable so that it can be easily applied over the edges of the rigid substrate 110. In some arrangements, the sealant in the first state 130 can be in a liquid or semi-liquid form.

Turning to FIG. 5, a curing process can be performed along the edges of the reflector 100 to form a sealant in a second state 132. In the second (e.g., cured) state 132, the sealant can be hardened to form a solid edge seal for the reflector 100. Curing the sealant to form the second state 132 can be advantageous in simultaneously sealing and protecting the reflector 100 edges. For example, the cured sealant can prevent moisture and other environmental contaminants from damaging the edge of the reflector 100 over time. In addition, the cured sealant can provide enhanced structural integrity for the reflector 100, as the hardened sealant material can ensure a secure bonding or lamination between the reflective film and the rigid substrate.

The curing process can comprise a thermal curing process in some embodiments. For example, in some embodiments, the sealant in the first state 130 can undergo a localized heating process to cure the sealant to the second state 132. In some embodiments, thermal curing processes can be used, including, a batch heating process or selective heating. In other embodiments, an optical curing process, e.g., an ultraviolet (UV) curing process, or a thermal curing process can be employed to cure the sealant from the first state 130 to the second state 132. In yet other embodiments, the sealant can be cured by exposing the sealant to the atmosphere to allow it to dry and harden. In one embodiment, a binary sealant material can be used. The binary sealant material can be composed of a sealant and a catalyst mixed with the sealant prior to dispensing. The catalyst can accelerate the curing rate of the sealant in the curing process.

FIGS. 6-8 illustrate another embodiment for fabricating a reflector 200 comprising a rigid substrate 210 coupled to a reflective film 222. Unless otherwise specified below, the numeric indicators used to refer to components in FIGS. 1-5 are similar to the components in FIGS. 6-8, except that the index has been incremented by 100.

As an alternative to dispensing a sealant directly to the reflector 200 edges (e.g., edges 204 and 206), a mold 260 can be attached over the edges of the reflector 200, as illustrated in FIG. 6. In some arrangements, the mold 260 can be applied around the perimeter of the reflector 200. The mold 260 can include first and second clamping portions 263, 264 that mechanically couple to the reflective surface 220 of the reflector and the back side 203 of the rigid substrate 210, respectively. The mold 260 can couple to the reflector 200 by way of a mechanical clamping force such that the first clamping portion 263 presses the film 222 to the surface of the substrate 210 against the force of the second clamping portion 264 pressing against the back surface of the substrate 210.

The mold 260 can be configured to generate a desired clamping force in any known manner, such as, for example, but without limitation, springs, actuators, screws, robotic arms, manual positioning of the clamps including the use of elastic retention members, interlocking clamps which cooperate to provide the clamping force, gearsets, etc. Additionally, the clamping force can be provided by way of the construction of the mold 260, such that in a relaxed state, the distance between the first and second clamping portions 263, 264 is less than a thickness of the substrate 210 and the film 222. In such embodiments, the mold 260 can be configured to be elastically expandable and resilient such that the first and second clamping portions 263, 264 can be elastically spread apart from each other, placed over the substrate 210 and film 222, then released so as to press against the substrate 210 and the film 222 as described above. In other embodiments, the first and second clamping portions 263, 264 of the mold 260 can be temporarily adhered to the reflector 200.

Upon coupling the mold 260 to the reflector 200, a recess 261 can be formed between the mold 260 and the first and second edges 204, 206 of the reflector 200. While the mold 260 illustrated in FIGS. 6-8 is applied around all four edges of the reflector 200, in other embodiments, the mold 260 may be applied around fewer than all the edges, e.g., one, two, or three edges of the reflector. In addition the mold 260 can be made from metal or plastic (which can be a reusable plastic). A skilled artisan will understand that other materials are suitable.

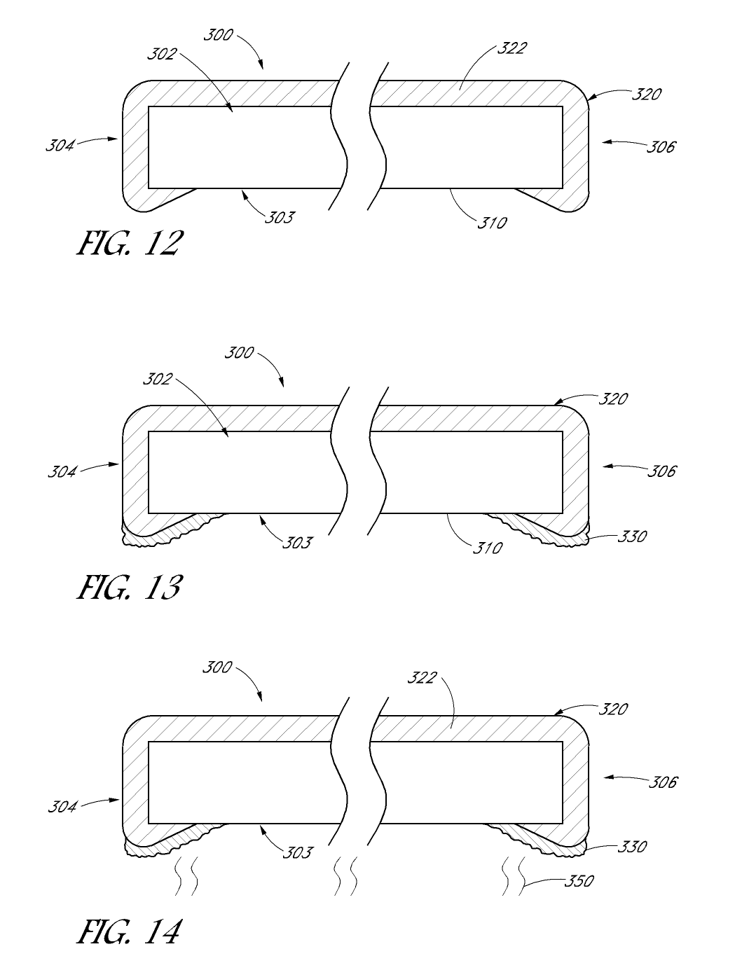

Turning to FIG. 7, a sealant in a first state 230 can be caused to flow through the recess 261 of the mold 260 and onto the reflector edges (e.g., first and second edges 204 and 206). For example, sealant can flow from a sealant source (e.g., a tube, sack, or other reservoir filled with flowable sealant) through an aperture or opening in the mold 260. The sealant in the first state 230 can be in a flowable state. In some arrangements, the sealant in the first state 230 can be in a liquid or semi-liquid form. As shown in FIG. 8, a curing step can be performed on the sealant in the first state 230 to form a sealant in a second state 232. As in the embodiment of FIGS. 4-5, the sealant can be cured using a thermal, UV, or atmospheric curing process, or any other suitable curing procedure. As above, any suitable sealant can be used, including, e.g., silicone or EVA. The sealant in the second state 232 can be in a solid form, e.g., hardened as compared to the uncured sealant. The mold 260 can be removed, completing the combined edge sealing and protection process.

With reference to FIGS. 9-11, another embodiment for fabricating a reflector 200 is shown. A laminate in a first state 234 can be adhered around the edges (e.g., first and second edges 204, 206) of the substrate. The laminate in a first state can be comprised of a flexible strip of a clear lamination polymer such as polyvinyl butyral (PVB) and EVA. Other suitable lamination materials are possible. In other embodiments, the laminate in the first state 234 can be a powder or resin applied around the edges of the reflector 200.

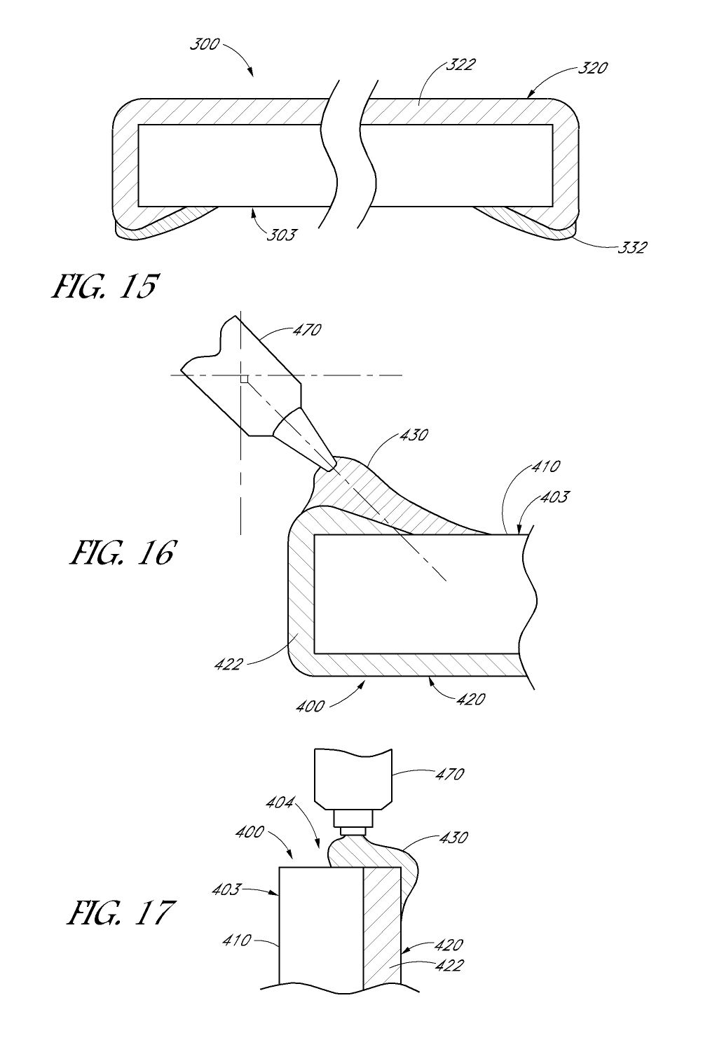

In FIG. 10, a laminating device 262 can be coupled to the edges of the substrate over the laminate in a first state 234. The laminating device 262 can be configured to bond the transparent laminate to the edges of the reflector 200. A lamination process can be performed to form a laminate in a second state 236, as illustrated in FIG. 11. In some implementations, the laminating device 262 can be configured to provide heat and/or pressure to perform the lamination process. The laminate in a second state 236 can be in a solid form, e.g., hardened as compared to the laminate in the first state 234. The laminating device 262 can be removed after completing the combined edge sealing and protection process. To conserve optical performance the sealant described in the embodiments above can comprise a clear sealant, e.g., having a refractive index of about 1.5.

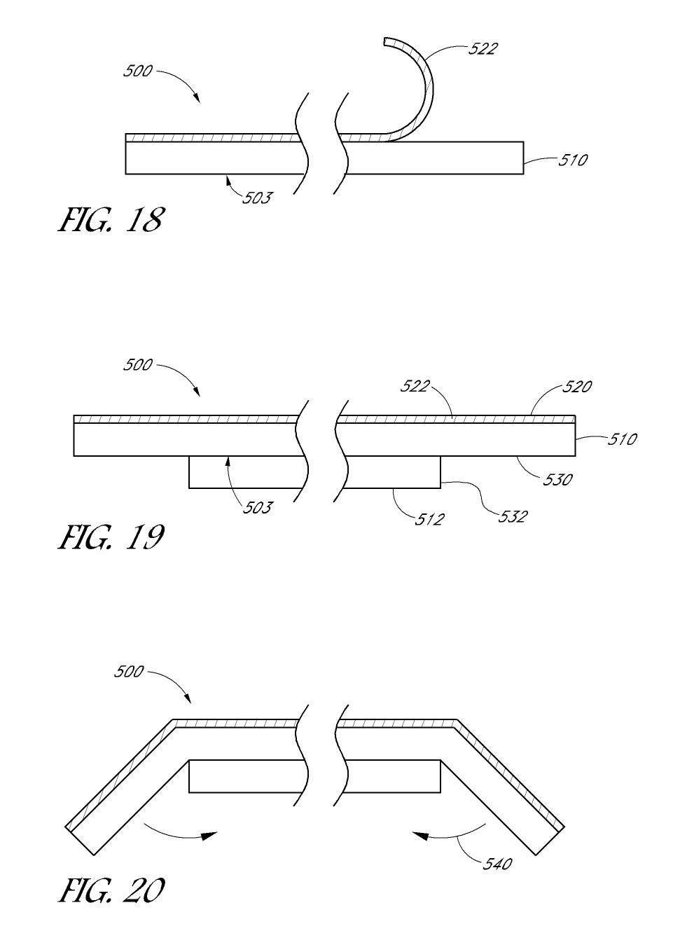

With reference to FIGS. 12-15, yet another embodiment for fabricating a reflector 300 is shown. An oversized reflective film 322 can be wrapped around the front side 302 and edges of the substrate to form a reflective upper surface 320 on top of the rigid substrate 310, as shown in FIG. 12. As illustrated, a portion of the reflective film 322 can be attached to the back side 303 of the rigid substrate 310.

Turning to FIG. 13, a sealant in a first state 330 can be dispensed on the back side 303 of the reflector 300 and on portions of the reflective film 322 that attach to the back side 303 of the rigid substrate 310. In some implementations, the sealant in the first state 330 can be applied to portions of the reflective film 322 that cover the edges (e.g., first and second edges 304, 306) of the reflector 300. By applying the sealant to the back side 303 of the rigid substrate 310, the front side 302 remains free of sealant. In some embodiments, the sealant in the first state 330 can be dispensed overlying the reflective film 323 and continuing onto the back side 303 of the rigid substrate 310.

A sealant-free front side 302 can be advantageous for various reasons. For example, applying the sealant to the back side 303 of the rigid substrate 310 can reduce any optical obstructions introduced by applying the sealant to the front side 302. Moreover, since the sealant is dispensed on the back side 303 of the reflector 300, the sealant need not be a transparent sealant. In addition, exposing the sealant to sunlight (e.g., by applying the sealant to a portion of the front side 302) can degrade the sealant over time in some cases. Applying the sealant to the back side 303 of the substrate 310 can therefore provide additional shielding of the sealant from direct sunlight and UV degradation. Such shielding can increase the reflector's overall durability.

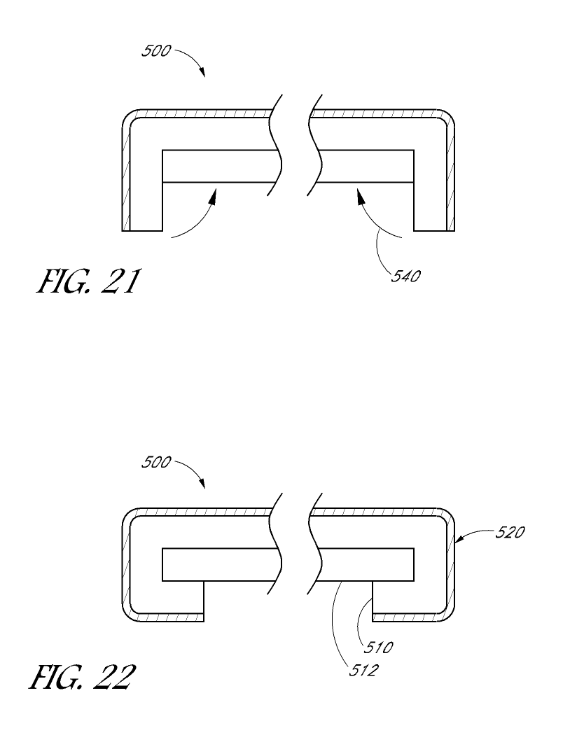

As illustrated in FIG. 14, a curing step can be performed on the sealant in a first state 330. In some embodiments, such as in FIG. 14, heat 350 is applied to cure the sealant from the first state 330 to a second state 332, as shown in FIG. 15. Other curing mechanisms, such as those described above, are also possible. As above, the sealant in the first state 330 can be in a flowable (e.g., liquid or semi-liquid) state. The sealant in the second state 332 can be a solid (e.g., hardened or cured) state. Any of the methods and materials described above can be employed in the embodiment of FIGS. 12-15.

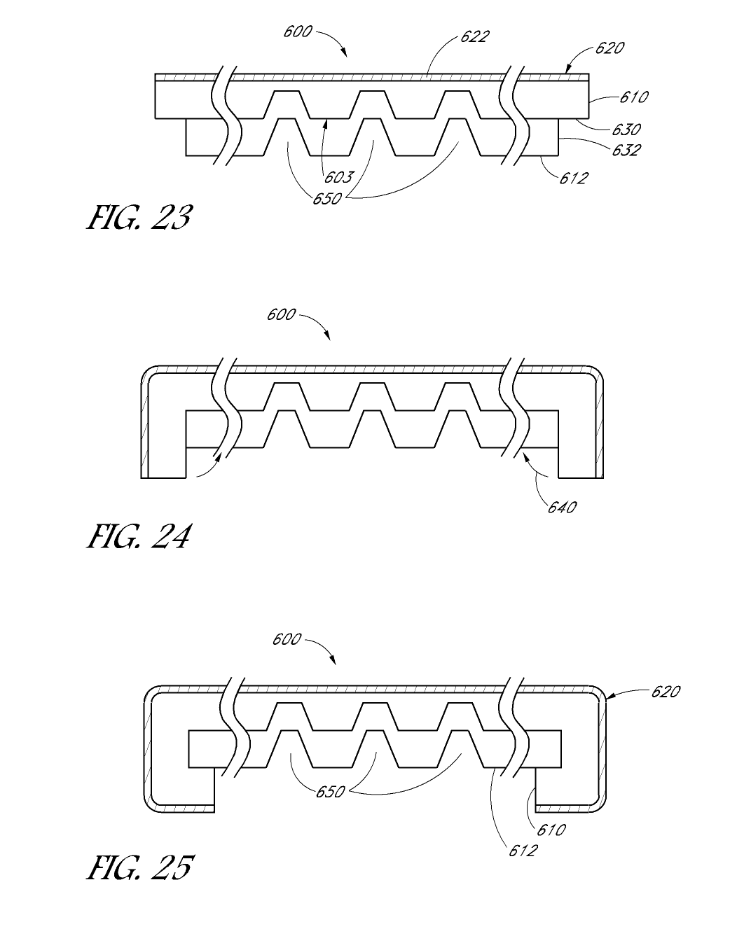

FIGS. 16 and 17 illustrate one way that the sealant can be dispensed on the back surface of the reflector 400 in the embodiment described by FIGS. 12-15. A print nozzle 470 can be placed at an angle (e.g., a 45 degree angle in FIG. 16) to the back side 403 of the substrate 410 using a hotmelt printer as seen in FIG. 16. While a 45 degree angle is shown in FIG. 16, it should be appreciated that the print nozzle 470 can be placed at any other suitable angle with the back side 403 of the rigid substrate 410. As above, the reflector 400 can comprise the rigid substrate 410, the reflective film 422, and the reflective upper surface 420, in addition to any of the other material combinations described above. As FIG. 17 illustrates, the print nozzle can also be perpendicular to the side edge (e.g., first edge 404) of the reflector 400. While the print nozzle 470 has been described in relation to the embodiment of FIGS. 12-15, the print nozzle 470 can be used in other embodiments as well, including, e.g., the embodiments of FIGS. 4-8.

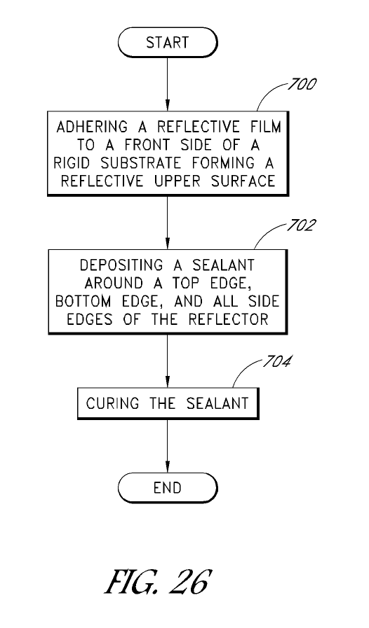

With reference to FIGS. 18-22, still another embodiment for fabricating a reflector 500 is shown. The reflector 500 can comprise a reflective film 522 defining a reflective upper surface 520, and a front assembly 510. As seen in FIG. 18, the reflective film 522 can be rolled and laminated or adhered onto the front assembly 510. The assembled reflector 500 is illustrated in FIG. 19. A back assembly 512 can be coupled to the back side 503 of the front assembly 510. The coupling process can comprise the addition of an adhesive to strengthen the contact between both structures. The back assembly 512 can provide structural support for the reflector 500. The back assembly 512 can also be configured to couple the reflector 500 to a larger system of solar reflectors, e.g., by coupling to an array of other reflectors (such as to an axis of the array).

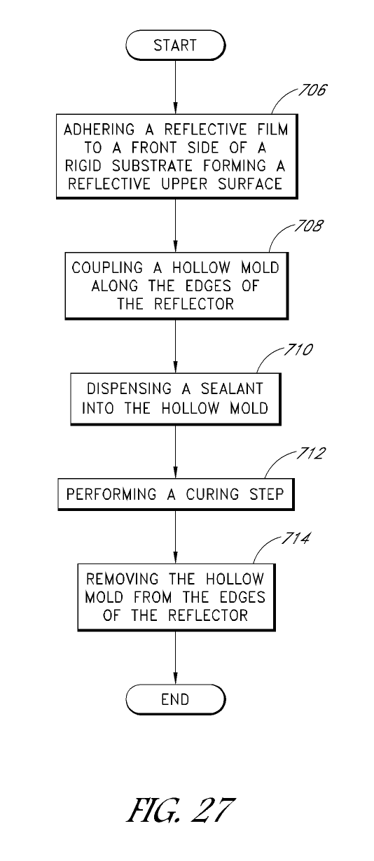

Turning to FIGS. 20-22, the front assembly 510 can be secured to the back assembly 512 by folding a flange portion 530 of the front assembly 510 over and around perimeter edges of the back assembly. To facilitate the folding process, the front assembly 510 can have an excess portion with a width range of 1 mm to 20 mm extending from the front assembly 510. This excess material or sacrificial material acts also to protect the edge of the reflector 500 against delamination. In FIG. 22, the flange portion 530 of the front assembly 510 can be further folded over the back assembly 512 such that a portion of the back side 503 of the front assembly 510 contacts an engagement flange 532 of the back assembly 512. The flange portion 530 can couple to the engagement flange 532 by mechanically clamping onto the engagement flange 532. In some embodiments, an adhesive can optionally be used to assist in coupling the flange portion 530 to the engagement flange 532. In some embodiments, the engagement flange 532 can be a structural extension of a portion of the back assembly 512. In other embodiments, the engagement flange 532 can be formed from a back surface of the back assembly 512. The folding process can be performed in a fold direction 540 as seen in FIGS. 20 and 21. During the process of coupling the front assembly 510 to the back assembly 512, the sealant can optionally be applied over the engagement flange 532 and the flange portion 530 of the front assembly 510. As above, the sealant can be applied in a first state (e.g., flowable) and cured to a second state (e.g., hardened or solid).

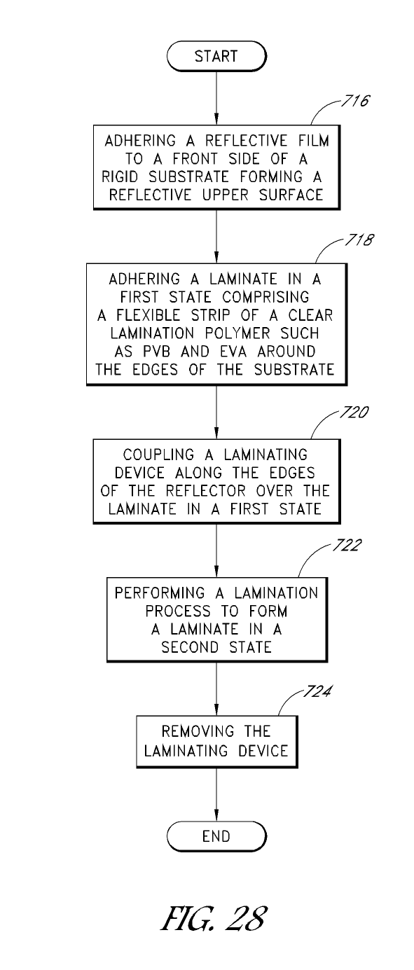

With reference to FIG. 23-25, another embodiment for fabricating a reflector 600 comprising a reflective film 622 and a front assembly 610 is shown. Similar to the embodiment discussed above in FIGS. 18-22, a back assembly 612 can be coupled to the back side 603 of the front assembly 610. The front assembly 610 can be secured to the back assembly 612 by folding a flange portion 630 of the front assembly 610 over and around perimeter edges of the back assembly to contact an engagement flange 632 of the back assembly 612. The folding process can be done in a fold direction 640 as seen in FIG. 24. Both the front assembly 610 and the back assembly 612 can comprise a cross strut structure 650 for additional structural support. For enhanced structural integrity the cross strut structure 650 can further comprise stiffening ribs. The folding process discussed above can comprise a hemming process similar to those performed in car manufacturing or other industrial hemming processes. The hemming process also allows for forming a sacrificial layer at the back of the reflector to prevent delamination and provides an alternative to the edge protection processes previously described.

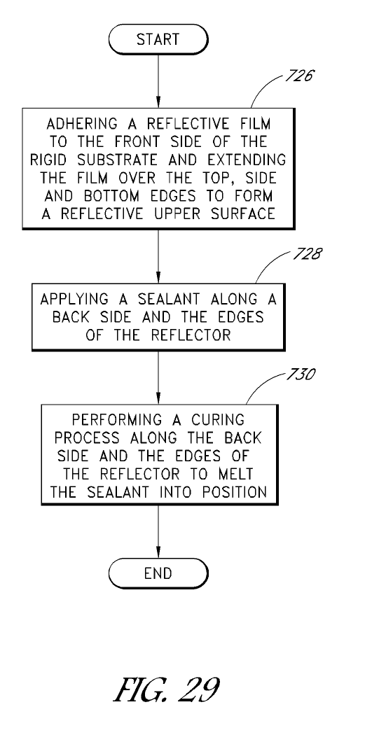

FIG. 26 illustrates a flow chart of an embodiment for fabricating a reflector 100. A first step 700 in the reflector fabrication method can comprise adhering a reflective film 122 to the front side 102 of a rigid substrate 110 to form a reflective upper surface 120. Adhering a reflective film can comprise rolling the reflective film 122 on the front side 102 of the rigid substrate 110. Adhering a reflective film 122 can also comprise rolling and subsequently laminating the reflective film 122 on the front side 102 of the rigid substrate 110. A sealant in a first state 130 can be deposited around the top edge, bottom edge, and all side edges of the reflector 100 as described in the second step 702 of the flow chart. Depositing the sealant in a first state 130 can comprise depositing a sealant in a flowable state such as silicone or EVA. The sealant can be made of a material with an optical index of about 1.5 to allow light transmission through the sealant and allow unobstructed reflection from the reflective upper surface 120. In other embodiments the sealant in a first state 130 can have at least 80% light transmission. A hotmelt printer can be used to deposit the sealant in a first state 130 along the edges of the reflector 100. The sealant in a first state 130 can be cured to form a sealant in a second state 132 as described in the last step 704 of the flow chart. The sealant in a second state 132 can be in a solid state and can also have at least 80% light transmission. Other processes, materials, and structures, such as those used in FIGS. 4-5, can be used with the embodiment of FIG. 26.

FIG. 27 illustrates a flow chart of another embodiment for fabricating a reflector 200. Similar to the above, the first step 706 in the reflector fabrication method can comprise adhering a reflective film to the front side of the rigid substrate 210 to form a reflective upper surface 220. A mold 260 can be coupled along the edges of the reflector 200 as shown in FIG. 6 and described in the second step 708 of the flow chart. The mold 260 can be made of metal or comprise a metal hollow mold. The mold 260 can also comprise of a reusable hollow plastic mold which can be recycled for use with another reflector. Turning to block 710, a sealant in a first state 230 can be dispensed into the mold 260. In block 712, a curing step can be performed to form a sealant in a second state 232. In block 714, the mold 260 can be removed from the edges of the reflector 200. The sealant in a first state 230 can be in a flowable state while the sealant in a second state can be in a solid state 232. In some embodiments, the mold 260 can be kept in contact with the reflector edge until the end of the fabrication process. In this embodiment, the mold 260 can provide additional structural support to the reflector 200 during succeeding reflector fabrication processes and removed after the fabrication process. In yet other embodiment, the mold 260 can be made of the same or similar material and optical properties of the sealant. This eliminates the requirement of removing the mold and sealant after the curing process, with no loss to the reflective properties of the reflector 200. Other processes, materials, and structures, such as those employed in FIGS. 6-8, can be used in the embodiment of FIG. 27.

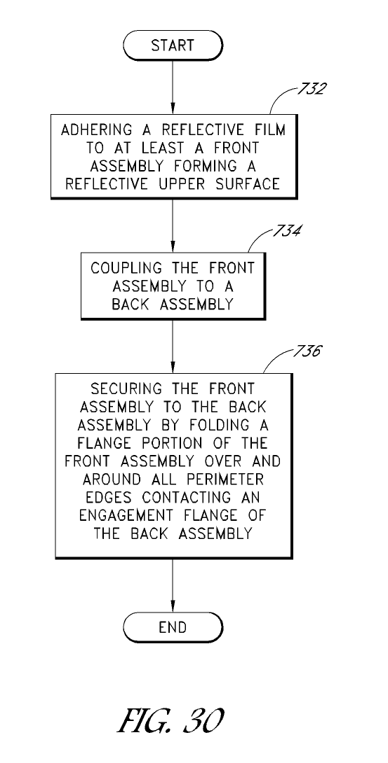

FIG. 28 illustrates a flow chart of another embodiment for fabricating a reflector 200. Similar to the discussion above, the first step 716 in the reflector fabrication method comprises adhering a reflective film to the front side of the rigid substrate 210 to form a reflective upper surface 220. A second step 718 can be performed, which can comprise adhering a laminate in a first state 234 around the edges of the substrate. The laminate in a first state 234 can comprise a flexible strip of a clear lamination polymer such as PVB or EVA. In block 720, a laminating device 262 can be coupled along the edges of the reflector 200 over the laminate in a first state 234. Turning to block 722, a lamination process can be performed to form a laminate in a second state 236. The lamination device 262 can be removed once the lamination process is complete in block 724. Other procedures, materials, and structures, similar to those described above with respect to FIGS. 9-11, can be employed in the embodiment of FIG. 28.

FIG. 29 illustrates a flow chart of another embodiment for fabricating a reflector 300. As discussed above, the first step 726 in the reflector fabrication method can comprise adhering a reflective film to the front side 302 of the rigid substrate 310 and extending the film over the top, side and bottom edges to form a reflective upper surface 320. A second step 728 can be performed in which a sealant in a first state 330 can be applied at the back side 303 of the reflector 300 along the first and second edges 304, 306. While FIG. 13 illustrates applying sealant to only two edges 304, 306, it should be appreciated that the sealant can also be applied on the other two edges of the reflector 300. The sealant in a first state 330 can also be applied at a 45° angle at the back side 303 of the reflector 300 as shown in FIG. 16, which allows optimal coverage of the interface between the reflective film and the back surface of the rigid substrate 310. Placing the sealant at the back side 303 of the reflector 300 has the advantage of shielding the sealant from direct sunlight and UV degradation, which would increase the overall durability of the reflector 300. A curing process 350 can be performed on the sealant in a first state 330 along the back side of the reflector 300 and edges to form a sealant in a second state 332 as described in the last step 730 of the flow chart. Other curing mechanisms, such as those described above, are also possible. The sealant in a first state 330 can be in a flowable state while the sealant in a second state can be in a solid state 332. Other procedures, materials, and structures, similar to those described above with respect to FIGS. 12-15, can be employed in the embodiment of FIG. 29.

FIG. 30 illustrates a flow chart of yet another embodiment for fabricating a reflector 500 and 600. Similar to that discussed above, the first step 732 in the reflector fabrication method can comprise adhering a reflective film 522 to at least the front assembly 510 to form a reflective upper surface 520. A second step 734 can be performed; the front assembly 510 can be coupled to the back assembly 512 by applying a sealant or by welding the interface between the front assembly 510 and back assembly 512. The front assembly 510 can be secured to the back assembly 512 by folding a flange portion 530 of the front assembly 510 in a folding direction 540 over and around perimeter edges to contact an engagement flange 532 of the back assembly 512. The folding process comprises the last step 736 of the flow chart. The folding process can comprise a hemming process for sealing the edge of the reflector 500 similar to that performed in the automotive industry. In some embodiments, the front assembly 510 and the back assembly 512 can have a stamped cross strut structure 650 that provides additional structural support. This can be further secured using a similar folding process as described by FIGS. 23-25. Other procedures, materials, and structures, similar to those described above with respect to FIGS. 18-25, can be employed in the embodiment of FIG. 30.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for sealing and protecting the edge of a reflector comprising a rigid substrate having a front side configured to face the sun during normal operation and a back side opposite the front side, the reflector having a top edge, a bottom edge and two opposite side edges, the method comprising:
adhering a reflective film to at least the front side of the rigid substrate to form a reflective upper surface;
depositing a sealant in a first state around the top edge, the bottom edge, and the side edges of the reflector, wherein the first state is a flowable state; and
curing the sealant to a second state, wherein the second state is a solid state.

2. The method of claim 1, wherein adhering a reflective film to at least the front side of the rigid substrate comprises adhering a reflective film to at least the front side of a glass substrate.

3. The method of claim 1, wherein depositing a sealant in a first state comprises depositing a sealant comprising an optical index of 1.5.

4. The method of claim 1, wherein depositing a sealant in a first state comprises depositing a sealant comprising a spectral window of at least 80% light transmission.

5. The method of claim 1, wherein depositing a sealant in a first state comprises depositing a sealant comprising silicone.

6. The method of claim 1, wherein depositing a sealant in first state comprises depositing ethylene-vinyl acetate (EVA) in a flowable state.

7. The method of claim 1, wherein depositing a sealant in a first state around a top edge, a bottom edge, and all side edges of the reflector comprises depositing a sealant with a thickness of less than 5 mm as measured from the front surface of the reflector along the side edges of the reflector.

8. The method of claim 1, wherein depositing a sealant in a first state around a top edge, a bottom edge, and the side edges of the reflector comprises depositing a sealant in a first state using a hotmelt printer.

9. The method of claim 1, wherein depositing a sealant around the top, bottom and side edges of the reflector comprises:
coupling a mold along the edges of the reflector;
dispensing the sealant into the mold along the edges of the reflector;
subsequent to the dispensing, performing the curing step; and
subsequent to the curing step, removing the mold from the edges of the reflector without removing the sealant to form the reflective upper surface.

10. The method of claim 9, wherein coupling a mold comprises coupling a hollow metal mold.

11. The method of claim 9, wherein coupling a mold comprises coupling a hollow mold comprising reusable plastic.

12. A method for sealing and protecting the edge of a reflector comprising a rigid substrate having a front side configured to face the sun during normal operation and a back side opposite the front side, the method comprising:
adhering a reflective film to at least the front side of the rigid substrate, and extending over a top edge, a bottom edge, and two opposing side edges of the rigid substrate to form a reflective upper surface;
applying a sealant at the back side of the rigid substrate along one of the edges; and
performing a curing process to melt the sealant into position.

13. The method of claim 12, wherein the sealant is applied at about a 45° angle from the back side of the rigid substrate.

14. A method for forming an assembled reflector comprising a front assembly having a flange portion and a back assembly having an engagement flange, the method comprising:
adhering a reflective film to at least the front assembly forming a reflective upper surface;
coupling the front assembly to the back assembly; and
securing the front assembly to the back assembly by folding the flange portion of the front assembly over and around edges of the back assembly to couple to the engagement flange.

15. The method of claim 14, wherein securing the front assembly to the back assembly further comprises welding the excess portion of the front assembly unto the back assembly from behind the back assembly.

16. The method of claim 14, wherein securing the front assembly to the back assembly further comprises applying a sealant on the interface between the front assembly and back assembly from behind the back assembly.

17. The method of claim 14, wherein providing a front assembly comprises providing a front assembly having an excess portion with a width range of 1 mm to 20 mm extending from the front assembly.

18. The method of claim 14, wherein securing the front assembly to the back assembly comprises a performing a hemming process on the front assembly unto the back assembly forming a reflector.

19. The method of claim 14, wherein providing a back assembly comprises providing a sheet of metal having a stamped cross strut structure.

20. The method of claim 19, wherein providing a sheet of metal having a stamped cross strut structure comprises providing a stamped cross strut structure with stiffening ribs.
